(19) United States
(12) Patent Application Publication
(10) Pub. No.: US 2020/0258203 A1
(43) Pub. Date: Aug. 13, 2020

(54) IMAGE OUTPUT APPARATUS AND CONTROL METHOD THEREOF

(71) Applicant: CANON KABUSHIKI KAISHA, Tokyo (JP)

(72) Inventor: Yosuke Takagi, Yokohama-shi (JP)

(21) Appl. No.: 16/747,878

(22) Filed: Jan. 21, 2020

(30) Foreign Application Priority Data
Feb. 13, 2019 (JP) 2019-023780

(51) Int. Cl. G06T 5/00; G09G 5/10

(52) U.S. Cl. CPC G06T 5/009; G06T 2207/20208; G09G 5/10

(57) ABSTRACT

An image output apparatus capable of displaying a plurality of images side by side on a display unit, the image output apparatus comprises an output unit configured to output images, a determination unit configured to determine a dynamic range of an image to be output by the output unit and a dynamic range of images that an output destination is capable of displaying, and a conversion unit configured to convert the dynamic range of the image to be output in accordance with the dynamic range that the output destination is capable of displaying if the dynamic range of the image to be output and the dynamic range that the output destination is capable of displaying do not match.

### BACKGROUND OF THE INVENTION

### Field of the Invention

The present invention relates to image output techniques for displaying images with different dynamic ranges.

### Description of the Related Art

Display apparatuses are being appeared that are capable of displaying a dynamic range wider than a conventional dynamic range. A dynamic range that can be expressed by conventional display apparatuses is called standard dynamic range (SDR), and a dynamic range wider than a dynamic range that can be expressed by conventional display apparatuses is called high dynamic range (HDR).

If an HDR image is displayed on an SDR-compliant (HDR-non-compliant) display apparatus, the image actually displayed would unfortunately have a tone differing from that of the HDR image. Due to this, in Japanese Patent Laid-Open No. 2015-5878 and International Publication No. 2015/198552, a configuration is adopted such that dynamic range conversion processing from HDR to SDR is performed if an HDR image is to be displayed on an HDR-non-compliant display apparatus, and dynamic range conversion processing is not performed if an HDR image is to be displayed on an HDR-compliant display apparatus.

In Japanese Patent Laid-Open No. 2015-5878 and International Publication No. 2015/198552, dynamic range conversion processing is performed if an HDR image is to be displayed on an SDR-compliant (HDR-non-compliant) display apparatus, but a case such as when both HDR images and SDR images are displayed in a coexisting state is not considered. For example, if dynamic range conversion processing is not performed on SDR images in a case in which SDR images and HDR images are to be displayed on an HDR-compliant display apparatus, images with different dynamic ranges will be displayed as a list, and thus, some of the images may be displayed with an unnatural tone.

### SUMMARY OF THE INVENTION

The present invention has been made in consideration of the aforementioned problems, and realizes techniques enabling all images to be displayed with a natural tone in a case in which images with different dynamic ranges are displayed.

In order to solve the aforementioned problems, the present invention provides an image output apparatus capable of displaying a plurality of images side by side on a display unit, the image output apparatus comprising: a memory and at least one processor and/or at least one circuit to perform operations of the following units: an output unit configured to output images; a determination unit configured to determine a dynamic range of an image to be output by the output unit and a dynamic range of images that an output destination is capable of displaying; and a conversion unit configured to convert the dynamic range of the image to be output in accordance with the dynamic range that the output destination is capable of displaying if the dynamic range of the image to be output and the dynamic range that the output destination is capable of displaying do not match.

In order to solve the aforementioned problems, the present invention provides a method of controlling an image output apparatus which includes an output unit configured to output images and which is capable of displaying a plurality of images side by side on a display unit, the method comprising: determining a dynamic range of an image to be output by the output unit and a dynamic range of images that an output destination is capable of displaying; and converting the dynamic range of the image to be output in accordance with the dynamic range that the output destination is capable of displaying if the dynamic range of the image to be output and the dynamic range that the output destination is capable of displaying do not match.

In order to solve the aforementioned problems, the present invention provides a non-transitory computer-readable storage medium storing a program that causes a computer to execute a method of controlling an image output apparatus which includes an output unit configured to output images and which is capable of displaying a plurality of images side by side on a display unit, the method comprising: determining a dynamic range of an image to be output by the output unit and a dynamic range of images that an output destination is capable of displaying; and converting the dynamic range of the image to be output in accordance with the dynamic range that the output destination is capable of displaying if the dynamic range of the image to be output and the dynamic range that the output destination is capable of displaying do not match.

According to the present invention, all images can be displayed with a natural tone in a case in which images with different dynamic ranges are displayed.

Further features of the present invention will become apparent from the following description of an exemplary embodiment (with reference to the attached drawings).

### BRIEF DESCRIPTION OF THE DRAWINGS

FIG. 1 is a block diagram illustrating an apparatus configuration in a present embodiment.

FIGS. 2A to 2E are diagrams illustrating examples of screens displayed in the present embodiment.

FIG. 3 is a flowchart illustrating image output processing in the present embodiment.

FIG. 4 is a flowchart illustrating rendering processing in the present embodiment.

### DESCRIPTION OF THE EMBODIMENT

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

[First Embodiment]

### <Apparatus Configuration>

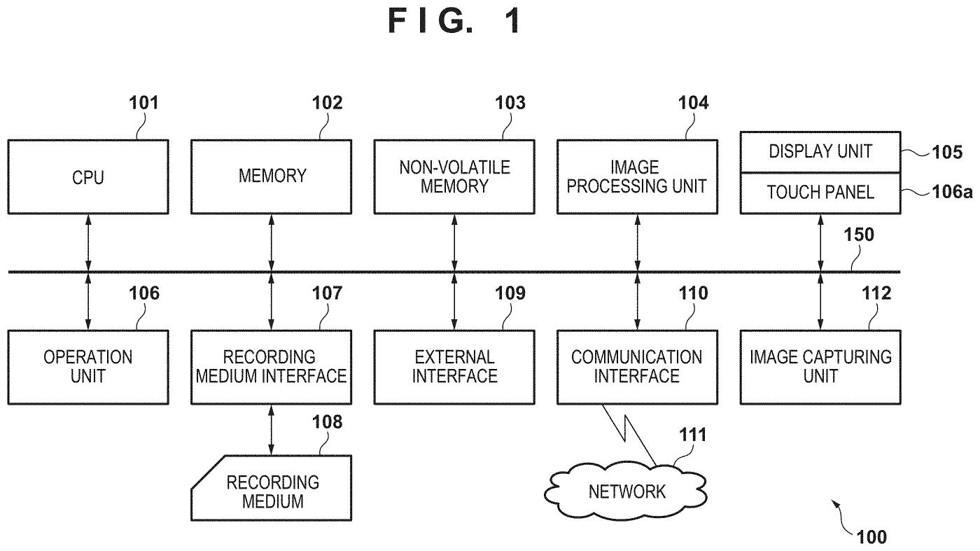

First, the configuration and functions of an image output apparatus 100 in the present embodiment will be described with reference to FIG. 1.

In the following, one example will be described in which the image output apparatus 100 in the present embodiment is applied to a personal computer.

In FIG. 1, a CPU 101, a memory 102, a non-volatile memory 103, an image processing unit 104, a display unit 105, an operation unit 106, a recording medium interface 107, an external interface 109, a communication interface 110, and an image capturing unit 112 are connected via an internal bus 150. The components connected to the internal bus 150 can exchange data with one another via the internal bus 150.

The CPU 101 controls the components of the image output apparatus 100 by executing programs stored in the non-volatile memory 103 and using the later-described memory 102 as a work memory.

The memory 102 is used as the work memory of the CPU 101, and is constituted by a RAM (a volatile memory in which a semiconductor element is used, or the like), for example.

The non-volatile memory 103 stores image data, audio data, and other types of data, and various programs to be executed by the CPU 101, etc., and is constituted by a hard disk (HDD), a flash ROM, or the like, for example.

The image processing unit 104, in response to control by the CPU 101, executes various types of image processing on image data stored in the non-volatile memory 103 and a recording medium 108, image signals acquired via the external interface 109, image data acquired via the communication interface 110, etc. Image processing executed by the image processing unit 104 includes A/D conversion processing, D/A conversion processing, image processing performed on image data, such as encoding processing, compression processing, decoding processing, scaling processing (resizing), noise reduction processing, color conversion processing, and dynamic range conversion processing, etc. Note that the image processing unit 104 may be constituted by a dedicated circuit module for performing a specific type of image processing. Also, certain types of image processing can be performed by the CPU 101 rather than the image processing unit 104.

The image processing unit 104 performs dynamic range conversion processing of converting standard dynamic range (SDR) image data into high dynamic range (HDR) image data having a wider dynamic range than the SDR image data, or dynamic range conversion processing of converting HDR images into SDR images. SDR is a tone characteristic corresponding to a dynamic range that can be displayed by conventional display apparatuses, and is defined by the ITU-R BT.709 specification, for example. On the other hand, high dynamic range (HDR), which is a dynamic range wider than a dynamic range that can be display by conventional display apparatuses, is defined by the Rec. ITU-R BT.2100 specification.

The display unit 105, in response to control by the CPU 101, displays images, a graphical-user-interface (GUI) screen constituting a GUI, etc. The CPU 101 generates, in accordance with a program, display control signals for displaying images on the display unit 105, and outputs the display control signals to the display unit 105. The display unit 105 displays images based on the image signals that are output. Note that a configuration may be adopted in which the apparatus itself includes the external interface 109, which is for outputting display control signals to the display unit 105, but does not include the display unit 105, and the display unit is constituted by an external monitor, television, etc., which are external devices.

The operation unit 106 is an input device for accepting user operations, and includes an information input device such as a keyboard, a pointing device such as a mouse or a touch panel, a button, a dial, a joystick, a touch sensor, a touch pad, etc. Note that a touch panel 106a is placed on the display unit 105 and planarly configured. The touch panel 106a is configured so that coordinate information corresponding to the position that is touched with a finger, a stylus, etc., is output to the CPU 101.

A recording medium 108 such as a memory card, a CD, DVD, BD, HDD, or the like can be attached to the recording medium interface 107, which writes and reads data to and from the recording medium 108 in response to control by the CPU 101.

The external interface 109 is connected to an external device via a wired or wireless connection, and is an interface for the input and output of image signals and audio signals.

The communication interface 110 communicates with an external device via a network 111 such as the internet or the like, and is an interface for performing the transmission and reception of various types of data, such as files and commands.

The image capturing unit 112 is constituted by an image sensor, etc. The image sensor is constituted of a CCD, a CMOS element, or the like that converts optical images into electric signals. The image capturing unit 112 includes a lens group (photographing lens) including a zoom lens and a focus lens, a shutter provided with an aperture function, the image sensor, and an A/D converter that converts analog signals output from the image sensor into digital signals. Furthermore, the image capturing unit 112 includes a barrier that covers the photographing lens, the shutter, and the image sensor and prevents contamination and damage. The image processing unit 104 performs color conversion processing and resizing processing, such as predetermined pixel interpolation and reduction, on data acquired by the image capturing unit 112. The CPU 101 performs exposure control, ranging control, and automatic-white-balance (AWB) processing based on computation results acquired from the image processing unit 104. Image data for displaying that has been captured by the image capturing unit 112 and subjected to image processing by the image processing unit 104 is displayed by the display unit 105. Live-view (LV) displaying can be performed by subjecting digital signals that have been captured by the image capturing unit 112, subjected to A/D conversion once by the A/D converter, and accumulated in the memory 102 to analog conversion by using a D/A converter and sequentially transferring the converted signals to the display unit 105 to be displayed. The live-view can be displayed in a still-image shooting standby state, in a moving-image shooting standby state, and during the recording of a moving image, and photographic subject images that are captured are displayed almost in real-time.

The CPU 101, in response to a shooting preparation instruction based on a user operation performed on the operation unit 106, controls the image capturing unit 112 and the image processing unit 104 so that operations involved in autofocus (AF) processing, automatic exposure (AE) processing, the AWB processing, etc., are started. The CPU 101, in response to a shooting instruction, performs control so that a sequence of operations involved in shooting processing (main shooting) is started. The sequence of operations includes performing main exposure and reading signals from the element in the image capturing unit, then subjecting the captured image to image processing by using the image processing unit 104 and generating an image file, and finally recording the image file to the recording medium 108. The shooting instruction can be provided by a user operation being performed on the operation unit 106. The image capturing unit 112 can shoot still images and moving images.

Furthermore, the CPU 101 can detect the following operations performed on the touch panel 106a included in the operation unit 106 and the following states of the touch panel 106a.

A touch on the touch panel 106a newly performed by a finger or pen that had not been touching the touch panel 106a, or that is, the start of a touch (referred to as “touch-down” in the following).

A state in which the touch panel 106a is being touched with a finger or pen (referred to as “touch-on” in the following).

The movement of a finger or pen while the touch panel 106a is being touched with the finger or pen (referred to as “touch-move” in the following).

The removal, from the touch panel 106a, of a finger or pen that had been touching the touch panel 106a, or that is, the end of a touch (referred to as “touch-up” in the following).

A state in which nothing is touching the touch panel 106a (referred to as “touch-off” in the following).

If touch-down is detected, touch-on is also concurrently detected. Unless touch-up is detected after touch-down, touch-on usually continues to be detected. Touch-move is also detected in a state in which touch-on is being detected. Unless the touch position moves, touch-move is not detected even if touch-on is detected. After touch-up of all fingers and pens that had been touching the touch panel 106a is detected, touch-off is detected. The CPU 101 is notified, via the internal bus, of these operations and states and the position coordinates on the touch panel 106a touched by a finger or a pen, and the CPU 101 determines what kind of operations (touch operations) are performed on the touch panel 106a based on the information the CPU 101 is notified of. With regard to touch-move, the direction of movement of the finger or pen moving on the touch panel 106a can also be determined for each of the vertical and horizontal components on the touch panel 106a, based on a change in the position coordinates. It is assumed that a determination that a slide operation has been performed is made if touch-move over a predetermined distance or more is detected. A “flick” refers to an operation in which a finger is quickly moved by only a certain distance with the finger kept touching on the touch panel 106a and is then removed without any further operation being performed. In other words, a flick is an operation of quickly sliding a finger over the touch panel 106a in a flick-like manner. It can be determined that a flick has been performed if a touch-move of a predetermined distance or more and at a predetermined speed or more is detected and then a touch-up is immediately detected (it can be determined that a flick has been performed following a slide operation). Furthermore, a “pinch-in” refers to a touch operation in which multiple positions (two positions, for example) are concurrently touched and the touch positions are moved toward one another, and a “pinch-out” refers to a touch operation in which multiple positions are concurrently touched and the touch positions are moved away from one another. The pinch-in and pinch-out are collectively referred to as a “pinch-operation” (or simply a “pinch”). A touch panel of any system may be used as the touch panel 106a, among touch panels of various systems such as the resistive film system, the electrostatic capacitance system, the surface acoustic wave system, the infrared system, the electromagnetic induction system, the image recognition system, and the optical sensor system. Depending on the system, a system may be adopted in which a touch is detected when contact is made to the touch panel or a system may be adopted in which a touch is detected when a finger or a pen approaches the touch panel, but either system suffices.

Note that while a case in which the image output apparatus of the present invention is applied to a personal computer has been described as an example in the present embodiment, there is no limitation to this. That is, the present invention may be applied to an image capturing apparatus such as a digital camera. That is, the present invention is also applicable to a case in which images that have been shot and recorded on a recording medium that a digital camera is capable of reading, such as a memory card, are to be displayed on a rear-surface monitor of the digital camera, on a display connected via an external interface of the digital camera, etc. Furthermore, the present invention is applicable to any apparatus capable of displaying images, such as smartphones, which are one type of mobile phones, tablet devices, wearable computers such as wristwatch-type smartwatches and spectacle-type smartglasses, PDAs, portable image viewers, printers including display units, digital photo frames, music players, game machines, and e-book readers.

<Examples of Screens Displayed>

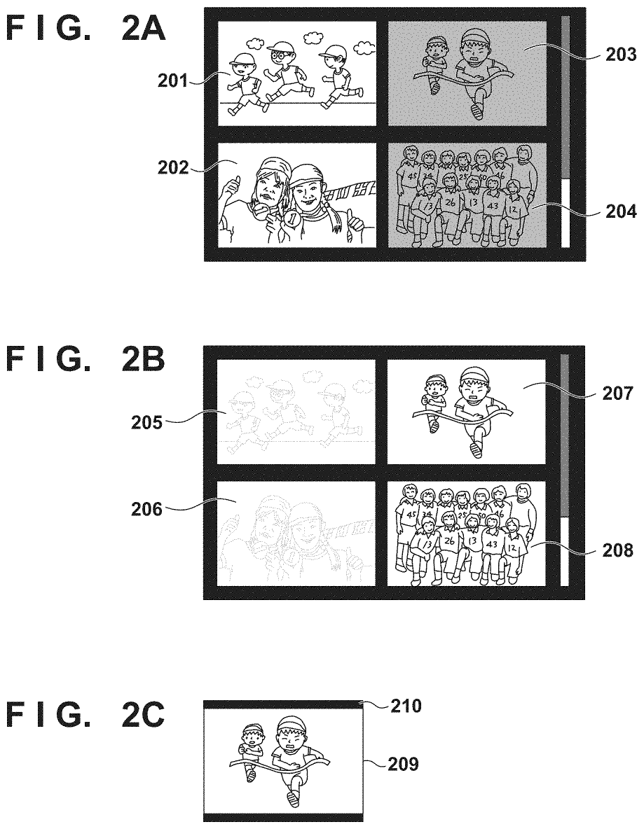

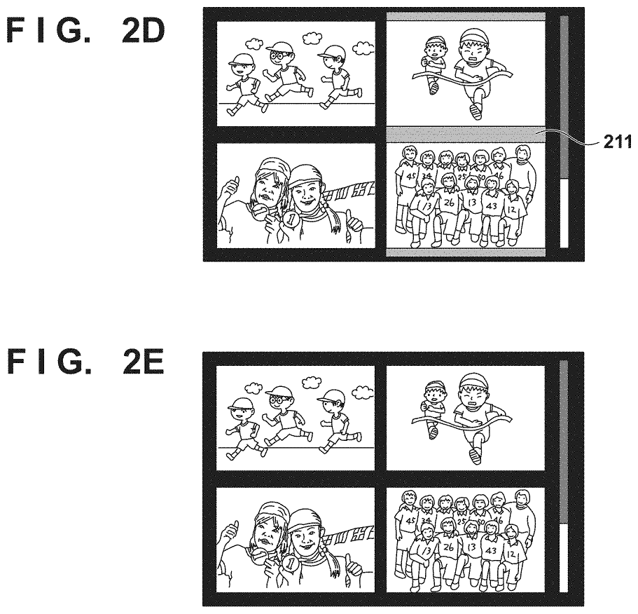

Next, examples of screens displayed in the present embodiment will be described, with reference to FIGS. 2A to 2E.

FIGS. 2A to 2E illustrate examples of index screens in which a plurality of image files recorded on the recording medium 108 are arranged side by side and displayed as a list. In the present embodiment, both SDR image files and HDR image files are stored in a coexisting state in a predetermined folder of the recording medium 108.

FIG. 2A illustrates an example of a playback screen of an SDR-compliant (HDR-non-compliant) output destination. Reference numerals 201 and 202 indicate SDR images, and reference numerals 203 and 204 indicate HDR images. On the SDR-compliant output destination, the SDR images 201 and 202 are displayed with their original tones (luminance and color), but the HDR images 203 and 204 are not displayed with their original tones because the HDR images 203 and 204 are output in HDR to an HDR-non-compliant output destination.

FIG. 2B illustrates an example of a playback screen of an HDR-compliant output destination. Reference numerals 205 and 206 indicate SDR images, and reference numerals 207 and 208 indicate HDR images. On the HDR-compliant output destination, the HDR images 207 and 208 are displayed with their original tones, but the SDR images 205 and 206 are not displayed with their original tones because the SDR images 205 and 206 are output in SDR to an HDR-compliant output destination.

In the cases in FIGS. 2A and 2B, it is common to perform dynamic range conversion processing between the SDR-compliant (HDR-non-compliant) output destination and the HDR-compliant output destination. However, when dynamic range conversion processing is performed on image data to be output to the display unit 105 and an external display apparatus, some images may be displayed with an unnatural tone if images with different dynamic ranges are displayed in a coexisting state as a list.

In view of this, dynamic range conversion processing is performed on individual pieces of image data in the present embodiment. Furthermore, if the output destination of image data is SDR-compliant (HDR-non-compliant), dynamic range conversion processing into SDR is performed on HDR images. Also, if the output destination is HDR-compliant, dynamic range conversion processing into HDR is performed on SDR images. By adopting such a configuration, it becomes possible to display all images with their natural tones at all times without looking unusual, regardless of whether the output destination is an SDR-compliant (HDR-non-compliant) output destination or an HDR-compliant output destination.

FIG. 2C illustrates the HDR image 203/207 recorded on the recording medium 108. The reference numeral 209 corresponds to a first image region of actual image data, and reference numeral 210 corresponds to a second image region of blank data for adjusting image size, outside the first image region. In a case in which dynamic range conversion processing is performed on image data as described above, dynamic range conversion processing would also be executed on the blank data 210 if conversion processing is directly performed on the image data illustrated in FIG. 2C. Furthermore, displaying image data in which the blank data 210 is also converted produces a result as illustrated in FIG. 2D. Reference numeral 211 indicates a second image region of blank data subjected to dynamic range conversion processing, and in such a manner, the background color of the actual image data and the tone of the blank data 210 do not match, causing a decrease in the quality of the appearance thereof. In view of this, in the present embodiment, the blank data 210 is removed in advance before dynamic range conversion processing is performed, and dynamic range conversion processing is performed only on the first image region 209 of actual image data. This processing is executed for both SDR images and HDR images. FIG. 2E illustrates an example of a playback screen of an SDR-compliant (or HDR-compliant) output destination to which the present embodiment has been applied.

<Image Output Processing>

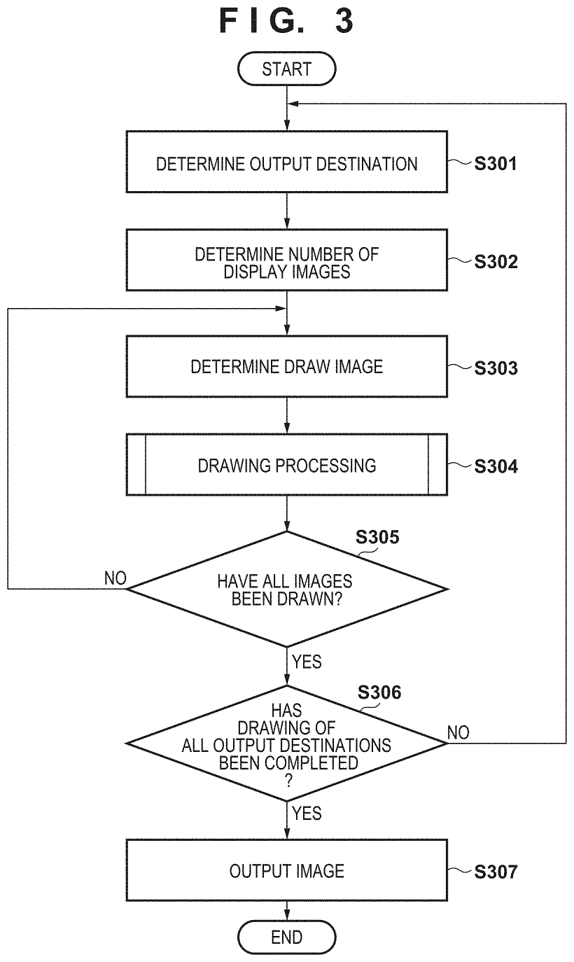

Next, image output processing in the present embodiment will be described with reference to the flowchart in FIG. 3.

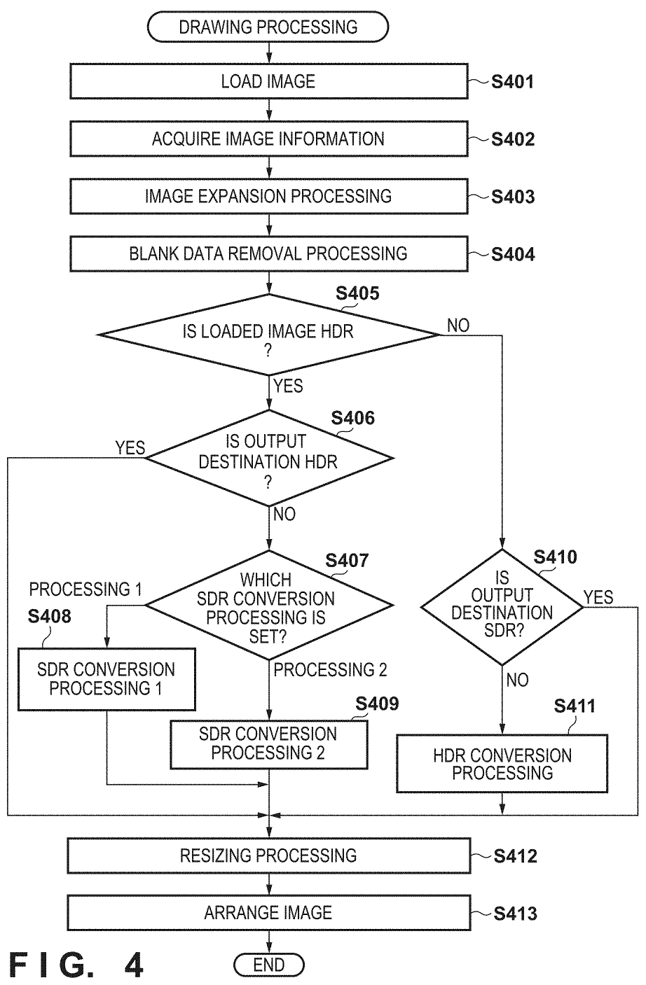

Note that the processing in FIG. 3 is realized by a program stored in the non-volatile memory 103 being decompressed on the memory 102 and by the CPU 101 executing the decompressed program. This is similar also in later-described FIG. 4.

In step S301, the CPU 101 determines the output destination. The CPU 101 determines whether to perform output to the display unit 105 or to perform output to an external display apparatus via the external interface 109.

In step S302, the CPU 101 determines the number of images to be displayed as a list.

In step S303, the CPU 101 determines an image to be rendered (drawn) on the memory 102. The CPU 101 sequentially determines an image to be rendered from among the images recorded in the recording medium 108.

In step S304, the CPU 101 performs rendering processing. Here, the image selected in S303 is rendered on the memory 102.

In step S305, the CPU 101 determines whether or not all images to be displayed as a list have been rendered. The CPU 101 proceeds to step S306 if determining that all images have been rendered, and returns to step S303 and determines an image to be rendered next if this is not the case.

In step S306, the CPU 101 determines whether or not rendering processing for all output destinations has been completed, if the same screen is to be output concurrently to a plurality of output destinations (the display unit 105 and the external display apparatus connected via the external interface 109). The CPU 101 proceeds to step S307 if determining that rendering processing for all output destinations has been completed, and returns to step S301 and chooses the output destination for which rendering processing is to be performed next if this is not the case.

In step S307, the CPU 101 performs output processing of outputting image data having been rendered on the memory 102 to the output destination. If there are a plurality of output destinations, image data having been rendered is output concurrently to all output destinations.

<Rendering Processing>

Next, the rendering processing in step S304 in FIG. 3 will be described with reference to the flowchart in FIG. 4.

In step S401, the CPU 101 loads the image file selected in step S303 from the recording medium 108 to the memory 102.

In step S402, the CPU 101 acquires information necessary for rendering from the image file loaded in step S401. Specifically, information indicating whether the loaded image file is an HDR image or an SDR image, the position of blank data if there is blank data as well as actual image data, etc., can be mentioned as examples of such information.

In step S403, the CPU 101 controls the image processing unit 104 and performs expansion processing on the image data loaded in step S401.

In step S404, the CPU 101 controls the image processing unit 104 and performs removal processing of blank data in the image data loaded in S401 based on the information acquired in step S402.

In step S405, the CPU 101 determines whether or not the image loaded in S401 is an HDR image. The CPU 101 proceeds to step S406 if determining that the image is an HDR image, and proceeds to S410 if this is not the case.

In step S406, the CPU 101 determines whether the HDR image, which is be output to the display unit 105 or the external apparatus, will be output to an HDR-compliant output destination. The CPU 101 proceeds to step S412 if the HDR image will be output to an HDR-compliant output destination, and proceeds to step S407 if this is not the case.

In step S407, the CPU 101 determines the setting of SDR conversion processing. The CPU 101 proceeds to step S408 if SDR conversion processing 1 is set, and proceeds to step S409 if SDR conversion processing 2 is set. If SDR conversion processing is to be performed on an HDR image, a user can choose either the SDR conversion processing 1 or the SDR conversion processing 2 as the SDR conversion processing. The SDR conversion processing 1 is SDR conversion processing that is capable of expressing a tone higher than a predetermined luminance by allocating the tone to the high-luminance-side of the HDR image. The SDR conversion processing 2 is SDR conversion processing that is capable of expressing a tone lower than the predetermined luminance by allocating the tone to the low-luminance-side of the HDR image.

In step S408, the CPU 101 performs the SDR conversion processing 1 on the image data expanded in step S403.

In step S409, the CPU 101 performs the SDR conversion processing 2 on the image data expanded in step S403.

In step S410, the CPU 101 determines whether the SDR image, which is to be output to the display unit 105 or the external apparatus, will be output to an SDR-compliant (HDR-non-compliant) output destination. The CPU 101 proceeds to step S412 if the SDR image will be output to an SDR-compliant (HDR-non-compliant) output destination, and proceeds to step S411 if this is not the case.

In step S411, the CPU 101 performs HDR conversion processing on the SDR image expanded in step S403.

In step S412, the CPU 101 performs, on image data expanded in step S403 or image data on which dynamic range conversion processing has been performed in step S408, S409, or S411, processing of resizing the image data into the size suitable for the output destination.

In step S413, the CPU 101 arranges the image data on which the resizing processing has been performed in step S412 at a predetermined screen position and renders the image data on the memory 102.

Note that while an index screen in which a plurality of images with different dynamic ranges are displayed in a coexisting state has been described as an example in the present embodiment, an image may be switched to a next image by a touch-move on a display unit in the case of an apparatus having a touch panel mounted thereon, for example. In this case, the use of an animation such that a displayed image is slid out of a screen and an image to be displayed next is slid into the screen can be considered, and if there is a difference in dynamic range between the displayed image and the next image, a plurality of images with different dynamic ranges would be present in a coexisting state on a list screen. Accordingly, the present embodiment is also applicable to such a case.

Note that in the above-described embodiment, the rendering processing is executed by performing dynamic range conversion processing, as appropriate, for each output destination if an image is to be output to a plurality of output destinations with different dynamic ranges. However, the processing would take too much time if there are many images and many output destinations. In view of this, a configuration may be adopted such that, if the display unit 105 is a SDR display apparatus and the external display apparatus is an HDR display apparatus for example, the rendering processing of a screen to be output to the display unit 105 is performed, and the entirety of the resultant screen is subjected to HDR conversion processing and output to the external interface 109.

Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-023780, filed on Feb. 13, 2019 which is hereby incorporated by reference herein in its entirety.

What is claimed is:

1. An image output apparatus capable of displaying a plurality of images side by side on a display unit, the image output apparatus comprising:
a memory and at least one processor and/or at least one circuit to perform operations of the following units:
an output unit configured to output images;
a determination unit configured to determine a dynamic range of an image to be output by the output unit and a dynamic range of images that an output destination is capable of displaying; and
a conversion unit configured to convert the dynamic range of the image to be output in accordance with the dynamic range that the output destination is capable of displaying if the dynamic range of the image to be output and the dynamic range that the output destination is capable of displaying do not match.

2. The apparatus according to claim 1, wherein
if the image includes a region of blank data outside a region of actual image data, the dynamic range conversion processing is performed on an image after the blank data is removed.

3. The apparatus according to claim 1, wherein
the output unit performs first output processing of outputting an image with a first dynamic range to an output destination that is capable of displaying images with the first dynamic range and second output processing of outputting an image with a second dynamic range to an output destination that is capable of displaying images with the second dynamic range,
the conversion unit performs first conversion processing of converting an image with the first dynamic range into an image with the second dynamic range and second conversion processing of converting an image with the second dynamic range into an image with the first dynamic range,
if an image with the first dynamic range is to be output through the first output processing, processing of converting an image with the second dynamic range into an image with the first dynamic range is performed through the second conversion processing, and
if an image with the second dynamic range is to be output through the second output processing, processing of converting an image with the first dynamic range into an image with the second dynamic range is performed through the first conversion processing.

4. The apparatus according to claim 3, wherein
as the second conversion processing, conversion processing capable of expressing a tone higher than a predetermined luminance and conversion processing capable of expressing a tone lower than the predetermined luminance are selectable.

5. The apparatus according to claim 1, wherein
if an image is to be output concurrently to a plurality of output destinations, the conversion unit performs the dynamic range conversion processing for each of the output destinations.

6. The apparatus according to claim 1, wherein
if an image is to be output concurrently to a plurality of output destinations each capable of displaying a different dynamic range of images, the conversion unit performs a conversion for achieving a dynamic range that can be displayed by a second output destination on an image converted to have a dynamic range that can be displayed by a first output destination.

7. The apparatus according to claim 3, wherein
the second dynamic range is a wider dynamic range than the first dynamic range.

8. The apparatus according to claim 7, wherein
the first dynamic range is standard dynamic range (SDR), and the second dynamic range is high dynamic range (HDR).

9. The apparatus according to claim 1, wherein
an image whose dynamic range has been converted by the conversion unit and which is output by the output unit is displayed on a list such that the image is displayed side by side with an image with the same dynamic range with which the output destination is compliant.

10. A method of controlling an image output apparatus which includes an output unit configured to output images and which is capable of displaying a plurality of images side by side on a display unit, the method comprising:
determining a dynamic range of an image to be output by the output unit and a dynamic range of images that an output destination is capable of displaying; and
converting the dynamic range of the image to be output in accordance with the dynamic range that the output destination is capable of displaying if the dynamic range of the image to be output and the dynamic range that the output destination is capable of displaying do not match.

11. A non-transitory computer-readable storage medium storing a program that causes a computer to execute a method of controlling an image output apparatus which includes an output unit configured to output images and which is capable of displaying a plurality of images side by side on a display unit, the method comprising:
determining a dynamic range of an image to be output by the output unit and a dynamic range of images that an output destination is capable of displaying; and
converting the dynamic range of the image to be output in accordance with the dynamic range that the output destination is capable of displaying if the dynamic range of the image to be output and the dynamic range that the output destination is capable of displaying do not match.
